(19) United States
(12) Patent Application Publication
(10) Pub. No.: US 2025/0153453 A1
(43) Pub. Date: May 15, 2025

(54) PROCESS FOR FORMING A WRAPPER WITH EMBOSSING

(71) Applicant: BERRY GLOBAL, INC., Evansville, IN (US)

(72) Inventor: Frank ESCHENBACHER, Schnelldorf (DE)

(21) Appl. No.: 18/941,547

(22) Filed: Nov. 8, 2024

Related U.S. Application Data
(60) Provisional application No. 63/597,488, filed on Nov. 9, 2023.

(51) Int. Cl. B31F 1/07

(52) U.S. Cl. CPC B31F 1/07; B31F 2201/0723; B31F 2201/0758

(57) ABSTRACT

A paper conditioning system is configured to prepare a plain, un-embossed paper sheet into an embossed paper sheet following a paper conditioning cycle or process. The embossed paper sheet can be used to create a paper wrapper for hygiene products that are worn by persons.

### PRIORITY CLAIM

This application claims priority under 35 U.S.C. § 119 (e) to U.S. Provisional Patent Application No. 63/597,488, filed Nov. 9, 2023, which is expressly incorporated by reference herein in its entirety.

### BACKGROUND

The present disclosure relates to a manufacturing method and system, and particularly to a conditioning system and method of conditioning an article. More particularly, the present disclosure relates to a paper or viscose non-woven conditioning system and a method of conditioning the sheet.

### SUMMARY

According to the present disclosure, a conditioning system is configured to prepare a plain, un-embossed sheet into an embossed sheet following a conditioning cycle or process. The embossed sheet can be used to create a wrapper for hygiene products that are worn by persons. In some examples the sheet may be paper or a viscose nonwoven.

In illustrative embodiments, the method of forming the embossed paper wrapper for a hygiene product includes advancing a plain, un-embossed paper sheet to a printing station. The method may further include applying a deposit to the plain, un-embossed paper sheet to provide a coated, un-embossed paper sheet. The method may further include drying the coated, un-embossed paper sheet. The method may further include moisturizing the coated, un-embossed paper sheet after the step of drying to provide a wetted, un-embossed paper sheet. The method may further include embossing the wetted, un-embossed paper sheet to provide the embossed paper sheet.

In illustrative embodiments, the paper conditioning system includes a printing station configured to apply one or more deposits on an un-embossed paper sheet. The paper conditioning system can further include a drying station configured to cure the one or more deposits on the un-embossed paper sheet to provide a coated, un-embossed paper sheet. The paper conditioning system can further include a wetting station configured to increase a moisture content of the coated, un-embossed paper sheet and provide a wetted, coated, un-embossed paper sheet. The paper conditioning system can further include an embossing station configured to emboss the wetted, coated, un-embossed paper sheet to provide the embossed paper sheet.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic of a paper conditioning system configured to condition an un-embossed paper sheet during a conditioning process, in accordance with the present disclosure, to produce an embossed paper sheet that can be used as a paper wrapper for hygiene products, the paper conditioning system including a printing station configured to apply one or more deposits on the un-embossed paper sheet, a drying station configured to cure the one or more deposits, a wetting station configured to increase a moisture content of the un-embossed paper sheet, and an embossing station configured to emboss the paper sheet;

FIG. 2 is a flowchart showing steps included in the process for preparing the un-embossed paper sheet into the embossed paper sheet using the paper conditioning system of FIG. 1;

FIG. 3 is a perspective view of the un-embossed paper sheet; and

FIG. 4 is a perspective view of the embossed paper sheet formed by the paper conditioning system of FIG. 1 and the flowchart of FIG. 2.

### DETAILED DESCRIPTION

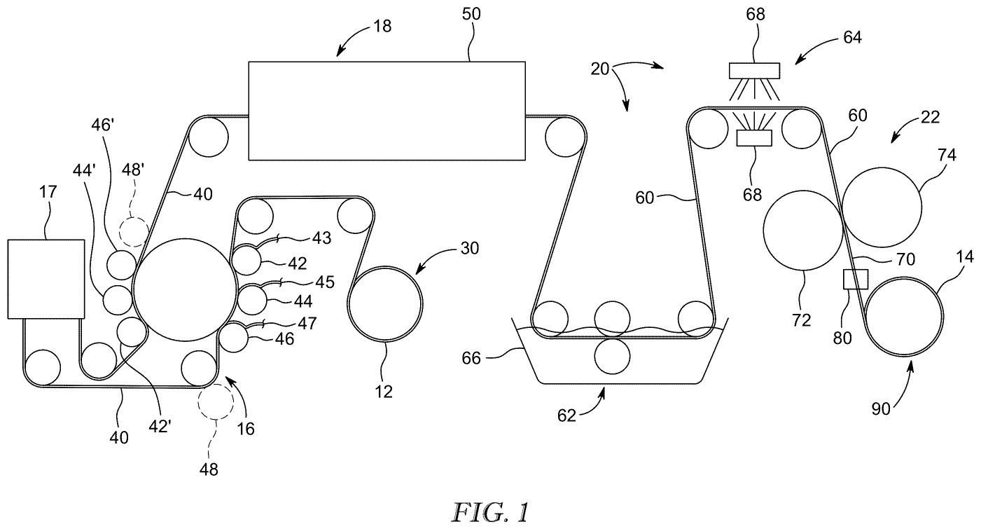

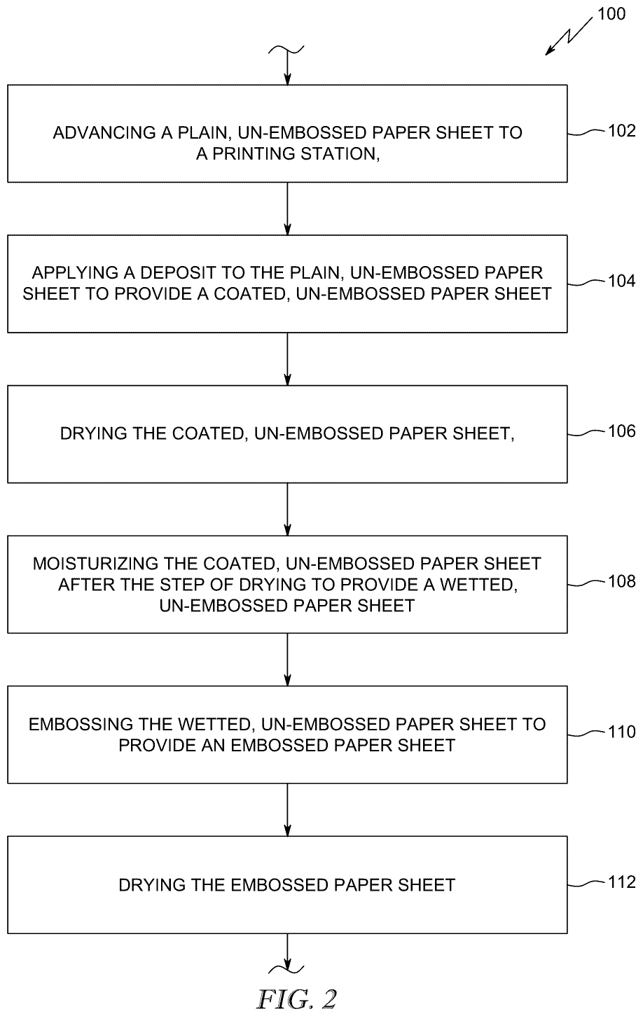

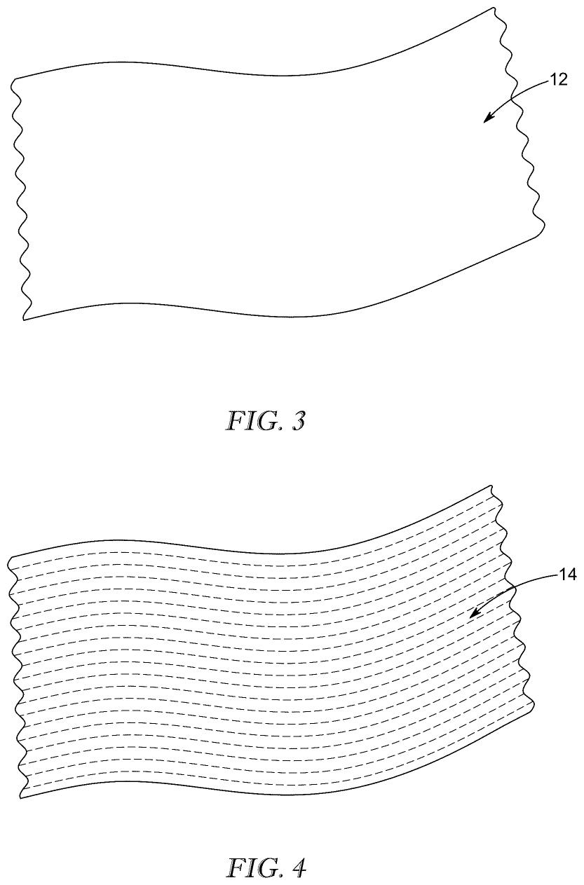

A conditioning system 10, in accordance with the present disclosure, is shown in FIG. 1. The conditioning system 10 is configured to prepare a plain, un-embossed sheet 12, as shown in FIG. 3, into an embossed sheet 14, as shown in FIG. 4, following a conditioning cycle or process 100. In one example the embossed sheet 14 has embossing showing as parallel broken lines running in parallel to longitudinal sides of the embossed sheet 14. In another example, the embossing patter may be perpendicular to the pattern show in FIG. 4. In yet another example, the embossing patter may be any suitable pattern or combination of patterns. The embossed sheet 14 can be used to create, for example, a wrapper for hygiene products that are worn by persons (i.e. a feminine hygiene product). In some examples, the sheet is made of paper or a viscose nonwoven.

The paper conditioning system 10 includes a plurality of rollers 14 as shown in FIG. 1. At least some of the rollers are configured to rotate (i.e. by one or more motors) to pull the plain, un-embossed paper sheet through a plurality of stations. The plurality of stations are each configured to provide one or more conditioning functions on or to the paper sheet to transform the plain, un-embossed paper sheet 12 into the embossed paper sheet 14 at the end of the process 100.

The plurality of stations includes a printing station 16, a drying station 18, a moisturizing station 20, and an embossing station 22 as shown in FIG. 1. The printing station 16 is configured to provide one or more deposits on the plain, un-embossed paper sheet 12. The drying station 18 is configured to cure the one or more deposits. The moisturizing station 20 is configured to add moisture to the paper sheet prior to the sheet being embossed. The embossing station 22 is configured to emboss the paper sheet. Illustratively, the paper sheet is embossed after all deposits, such as attachment components used to attach the end product to a user, artwork, additives, etc., have been applied to the un-embossed sheet so that application of these deposits is facilitated. Other comparative systems use pre-embossed paper which may require a more robust and complicated system and planning to address the brittle state of the pre-embossed paper as a result of having embossments.

The process 100 illustratively begins with a step 102 of advancing the plain, un-embossed paper sheet 12 to the printing station 16. In the illustrative embodiment, the plain, un-embossed paper sheet 12 is initially in a roll 30 which is unwound by the plurality of rollers. The printing station 16 can include or be any suitable device for applying deposits such as rotary printing device, transfer roller(s), a sprayer, an inkjet printer, an offset printer, etc.

The process 100 further includes a step 104 of applying one or more deposits to the plain, un-embossed paper sheet 12 at the printing station 16 to provide a coated, un-embossed paper sheet 40. The step 104 of applying the deposit illustratively includes applying a primer layer 43 to the plain, un-embossed paper sheet 12. The primer layer 43 may be applied to all or only a portion of the plain, un-embossed paper sheet 12. The step 104 of applying the deposit illustratively includes applying a release layer 45 to the primer layer 43. The release layer 45 may be applied to all or only a portion of the primer layer 43. The step 104 of applying the deposit further includes applying a heat seal layer 47 to the release layer 45. The heat seal layer 47 may be applied to all or only a portion of the release layer 45. Illustratively, each of the layers are applied by separate transfer rollers 42, 44, 46. The printing station 16 can further include an additional roller 48 and step 104 of applying the deposit may further include applying an ink layer to any portion of the paper sheet or any of the layers thereon.

In the illustrative embodiment, the system 10 further includes a turning station 17 configured to flip the coated, un-embossed paper sheet after receiving the primer layer 43, the release layer 45, the heat seal layer 47, and/or the ink layer on one side thereof for further printing on an opposed side of the coated, un-embossed paper sheet. Thus, the step 104 may include flipping the coated, un-embossed paper sheet 40 and applying one or more additional deposits to the other side of the paper sheet. The additional deposits can include a second primer layer, a second heat seal layer, and/or a second ink layer on the opposite side of the coated, un-embossed paper sheet using a second set of rollers 42′, 44′, 46′, and/or 48′. Pre-embossed paper sheets are typically thicker and more absorptive than un-embossed paper sheets. Accordingly, the present disclosure allows for reduced levels of deposits since the deposits are applied on the paper sheet prior to embossing. Pre-embossed paper sheets also tend to have a lower tensile strength than un-embossed paper sheets. Thus, use of the un-embossed paper sheet can allow application of a tensile load on the paper sheet for increased accuracy in printing, increased throughput rates, etc.

The process 100 may further include a step 106 of drying the coated, un-embossed paper sheet 40. The step 106 of drying is illustratively performed in an oven 50 having one or more heating elements. The oven 50 is configured to cure the deposits on the coated, un-embossed paper sheet 40. One or more of conductive, convective, and/or radiant heating can be used in the step 106 by the oven 50 and/or heating elements. In some embodiments, the turning station 17 can also include one or more heating elements to provide a first oven configured to dry the first set of deposits from rollers 42, 44, 46, 48 and the oven 50 is a second oven configured to dry the second set of deposits from the rollers 42′, 44′, 46′, 48′.

The process 100 may further include a step 108 of moisturizing the coated, un-embossed paper sheet 40 after the step 106 of drying to provide a wetted, un-embossed paper sheet 60. Illustratively, the step 108 of moisturizing is performed in two stages using a wetting station 62 and a spray station 64. The step 108 of moisturizing includes advancing the coated, un-embossed paper sheet 40 through a reservoir 66 of liquid including water at the wetting station 62. The liquid can include one or more additives with the water in some embodiments. The step 108 of moisturizing further includes spraying liquid including water on the coated, un-embossed paper sheet 40 at the spray station 64 using one or more spray nozzles 68 after advancing the coated, un-embossed paper sheet through the reservoir 66 of liquid. In some embodiments, only one of the wetting station 62 and the spray station 64 may be used to complete the step 108 of moisturizing.

The wetting station 62 and the spray station 64 are configured to apply a predetermined amount of liquid to the coated, un-embossed paper sheet 40. Illustratively, the step of advancing the coated, un-embossed paper sheet 40 through the reservoir includes selecting an amount of time that the coated, un-embossed paper sheet is submerged in the reservoir 66 so that the wetted, un-embossed paper sheet 60 has a predetermined moisture content. For example, a length of the reservoir 66 can be selected based on the velocity of the sheet of paper flowing therethrough so that the sheet of paper is exposed to the liquid for a predetermined amount of time. The step of spraying the liquid on the coated, un-embossed paper sheet can include discharging a predetermined amount of liquid from one or more spray nozzles 68 so that the wetted, un-embossed paper sheet 60 has the predetermined moisture content. The rollers or other devices conveying the sheet through the system may be synced with the flow rate of liquid being sprayed on the sheet so that the predetermined amount of liquid is deposited on the sheet during the step of spraying.

The predetermined moisture content facilitates embossing in later steps in the process 100. In the illustratively embodiment, the predetermined moisture content is within a range of about 3 grams of the liquid per square meter (gsm) and about 10 gsm. In some embodiments, the predetermined moisture content is within a range of about 4 gsm to about 8 gsm. In some embodiments, the predetermined moisture content is within a range of about 5 gsm to about 7 gsm. In some embodiments, the predetermined moisture content is about 6 gsm. The term about means, for example, within 5%.

The process 100 further includes a step 110 of embossing the wetted, un-embossed paper sheet 60 to provide an embossed paper sheet 70. The step 110 of embossing includes rolling the wetted, un-embossed paper sheet 60 between a rigid roller (i.e. metallic/steel roller) 72 having a plurality of protrusions projecting toward the wetted, un-embossed paper sheet 60 and a compliant roller (i.e. rubber roller) 74. The projections are configured to provide the embossments on the paper sheet as the wetted, un-embossed paper sheet 60 passes between the rigid roller 72 and the compliant roller 74.

The process 100 further includes a step 112 of drying the embossed paper sheet 70. The step 112 of drying is performed in a separate oven 80 from oven 50, although, in some embodiments, the oven 50 may be used. Each oven 50, 80 may vary from one another in at least one of heat intensity/magnitude and length to cause different drying behaviors. Following drying, the embossed paper sheet 70 may be re-wound into a roll 90 to await further processing to form a paper wrapper, for example, for a hygiene product. In some examples, the paper wrapper may be free of plastic which may be useful to help with recyclability and/or composting. In some embodiments, the paper forming the wrapper is a nonwoven paper sheet.

In another example where a viscose nonwoven sheet is used, the process 100 may use a treatment step which includes two stages using a first heating stage and a second heating stage. This treatment step is in place of step 104. In the first heating stage, the viscose nonwoven sheet may pass through pair of heated rollers. In one example, the heated rollers are about 100 degrees Celsius. In the second heating stage, the heated viscose nonwoven sheet is further heated by infrared heater. In one example the infrared heater applies abut 60 kw to the heated viscose nonwoven sheet prior to embossing.

The following numbered clauses include embodiments that are contemplated and non-limiting:
Clause 1. A method of forming an embossed wrapper for a hygiene product, the method comprising steps of advancing a plain, un-embossed sheet to a printing station.
Clause 2. The method of clause 1, any other suitable clause, or any suitable combination of clauses, wherein the plain, un-embossed sheet comprises paper.
Clause 3. The method of clause 2, any other suitable clause, or any suitable combination of clauses, further comprising applying a deposit to the plain, un-embossed sheet to provide a coated, un-embossed sheet.
Clause 4. The method of clause 3, any other suitable clause, or any suitable combination of clauses, further comprising drying the coated, un-embossed sheet.
Clause 5. The method of clause 4, any other suitable clause, or any suitable combination of clauses, further comprising moisturizing the coated, un-embossed sheet after the step of drying to provide a wetted, un-embossed sheet.
Clause 6. The method of clause 5, any other suitable clause, or any suitable combination of clauses, further comprising embossing the wetted, un-embossed sheet to provide the embossed sheet.
Clause 7. The method of clause 6, any other suitable clause, or any suitable combination of clauses, further comprising drying the embossed sheet.
Clause 8. The method of clause 7, any other suitable clause, or any suitable combination of clauses, wherein each step of drying is performed in an oven.
Clause 9. The method of clause 7, any other suitable clause, or any suitable combination of clauses, wherein each step of drying is performed in a separate oven.
Clause 10. The method of clause 9, any other suitable clause, or any suitable combination of clauses, wherein the separate ovens vary from one another in at least one of heat intensity/magnitude and length.
Clause 11. The method of clause 6, any other suitable clause, or any suitable combination of clauses, wherein the step of applying the deposit includes applying a primer layer to the plain, un-embossed sheet.
Clause 12. The method of clause 11, any other suitable clause, or any suitable combination of clauses, wherein the step of applying the deposit includes applying a release layer to the primer layer.
Clause 13. The method of clause 12, any other suitable clause, or any suitable combination of clauses, wherein the step of applying the deposit includes applying a heat seal layer to the release layer.
Clause 14. The method of clause 13, any other suitable clause, or any suitable combination of clauses, wherein the step of applying the deposit includes applying an ink layer.
Clause 15. The method of clause 13, any other suitable clause, or any suitable combination of clauses, further comprising flipping the coated, un-embossed sheet and applying a second primer layer and a second heat seal layer on an opposite side of the coated, un-embossed sheet.
Clause 16. The method of clause 15, any other suitable clause, or any suitable combination of clauses, further comprising applying a first ink layer on a first side of the embossed sheet and applying a second ink layer on the opposite side of the coated, un-embossed sheet.
Clause 17. The method of clause 6, any other suitable clause, or any suitable combination of clauses, wherein the step of moisturizing includes advancing the coated, un-embossed sheet through a reservoir of liquid including water.
Clause 18. The method of clause 17, any other suitable clause, or any suitable combination of clauses, wherein the step of moisturizing further includes spraying liquid including water on the coated, un-embossed 1 sheet after advancing the coated, un-embossed 1 sheet through the reservoir of liquid.
Clause 19. The method of clause 17, any other suitable clause, or any suitable combination of clauses, wherein advancing the coated, un-embossed sheet through the reservoir includes selecting an amount of time that the coated, un-embossed sheet is submerged in the reservoir so that the wetted, un-embossed sheet has a predetermined moisture content following the step of advancing the coated, un-embossed sheet through the reservoir of liquid.
Clause 20. The method of clause 18, any other suitable clause, or any suitable combination of clauses, wherein spraying the liquid on the coated, un-embossed sheet includes discharging a predetermined amount of liquid from one or more spray nozzles toward the coated, un-embossed sheet so that the wetted, un-embossed sheet has a predetermined moisture content following the step spraying the liquid including water on the coated, un-embossed sheet.
Clause 21. The method of clause 6, any other suitable clause, or any suitable combination of clauses, wherein the step of embossing includes rolling the wetted, un-embossed paper sheet between a metallic roller having a plurality of protrusions projecting toward the wetted, un-embossed sheet and a rubber roller.
Clause 22. The method of clause 1, any other suitable clause, or any suitable combination of clauses, wherein the plain, un-embossed sheet is wound in a roll prior to the step of advancing the plain, un-embossed sheet to the printing station, and the step of advancing the plain, un-embossed sheet to the printing station includes applying a tensile force on the plain, un-embossed paper sheet above a tear strength of the embossed sheet.
Clause 23. The method of clause 22, any other suitable clause, or any suitable combination of clauses, further comprising a step of re-winding the embossed sheet into a second roll.
Clause 24. The method of clause 4, any other suitable clause, or any suitable combination of clauses, further comprising heating the coated, un-embossed sheet after the step of drying to provide a conditioned, un-embossed sheet.
Clause 25. The method of clause 24, any other suitable clause, or any suitable combination of clauses, wherein the heating step includes a first heating step where the coated, un-embossed sheet passes between two heated rollers.
Clause 26. The method of clause 25, any other suitable clause, or any suitable combination of clauses, wherein the heating step further includes a second heating step where the coated, un-embossed sheet is further heated by a heater.
Clause 27. The method of clause 26, any other suitable clause, or any suitable combination of clauses, wherein the heater is an infrared heater.
Clause 28. The method of clause 27, any other suitable clause, or any suitable combination of clauses, wherein the heater emits about 60 kw.
Clause 29. The method of clause 25, any other suitable clause, or any suitable combination of clauses, wherein the heated rollers are heated to about 100 degrees Celsius.
Clause 30. A conditioning system configured to form an embossed sheet, the conditioning system comprising: a printing station configured to apply one or more deposits on an un-embossed sheet.
Clause 31. The conditioning system of clause 30, any other suitable clause, or any suitable combination of clauses, further comprising a drying station configured to cure the one or more deposits on the un-embossed sheet to provide a coated, un-embossed sheet.
Clause 32. The conditioning system of clause 31, any other suitable clause, or any suitable combination of clauses, further comprising a conditioning station configured to receive the coated, un-embossed sheet and provide a conditioned, un-embossed sheet.
Clause 33. The conditioning system of clause 32, any other suitable clause, or any suitable combination of clauses, further comprising an embossing station configured to emboss the conditioned, un-embossed sheet to provide the embossed sheet.
Clause 34. The conditioning system of clause 33, any other suitable clause, or any suitable combination of clauses, wherein the un-embossed sheet is made from paper.
Clause 35. The conditioning system of clause 34, any other suitable clause, or any suitable combination of clauses, wherein the conditioning station includes a wetting station configured to increase a moisture content of the coated, un-embossed sheet and provide the conditioned, un-embossed sheet.
Clause 36. The conditioning system of clause 35, any other suitable clause, or any suitable combination of clauses, wherein the wetting station includes a reservoir containing liquid and configured to submerge the coated, un-embossed sheet in the liquid and a sprayer configured to spray liquid on the coated, un-embossed sheet.
Clause 37. The conditioning system of clause 33, any other suitable clause, or any suitable combination of clauses, wherein the un-embossed sheet is made from viscose nonwoven.
Clause 38. The conditioning system of clause 37, any other suitable clause, or any suitable combination of clauses, wherein the conditioning station includes a first heating stating configured to pass the coated, un-embossed sheet between two heated rollers.
Clause 39. The conditioning system of clause 38, any other suitable clause, or any suitable combination of clauses, wherein conditioning station includes a second heating station in which the coated, un-embossed sheet is further heated after the first heating station by an infrared heater to provide the conditioned, un-embossed sheet.
Clause 40. The conditioning system of clause 39, any other suitable clause, or any suitable combination of clauses, wherein the heater is an infrared heater.
Clause 41. The conditioning system of clause 40, any other suitable clause, or any suitable combination of clauses, wherein the heater emits about 60 kw.
Clause 42. The conditioning system of clause 39, any other suitable clause, or any suitable combination of clauses wherein the heated rollers are heated to about 100 degrees Celsius.

A first example is described in Table 1. Table 1 describes various properties and characteristics of one example of an embossed paper sheet 14 produced by process 100 and by paper conditioning system 10.

TABLE 1

| | Test | | | | | |
|---|---|---|---|---|---|---|
| Characteristics | Method | Units | Target | LSL | USL | Average |
| Basis Weight | WSP | g/m² | 20.00 | 18.00 | 22.00 | 20.05 |
| | 130.1 | | | | | |
| Strike- | WSP 70.3 | S | 2.00 | 0.00 | 3.00 | 1.35 |
| Through Time | | | | | | |
| Wetback | WSP 80.1 | g | 0.20 | 0.00 | 0.30 | 0.12 |
| M.D. Tensile | WSP | N | 40.00 | 25.00 | | 38.61 |
| Strength | 110.4 | | | | | |
| M.D. | WSP | % | 30.00 | 15.00 | | 29.66 |
| Elongation at | 110.4 | | | | | |
| peak | | | | | | |
| C.D. Tensile | WSP | N | 6.50 | 3.50 | | 11.19 |
| Strength | 110.4 | | | | | |
| C.D. | WSP | % | 65.00 | 30.00 | | 67.79 |
| Elongation at | 110.4 | | | | | |
| peak | | | | | | |
| Embossed | DIN53370/ | mi- | | | | 320 |
| thickness | ISO | crom- | | | | |
| | 4593 | eter | | | | |

A second example is described in Table 2. Table 2 describes various properties and characteristics of one example of a viscose nonwoven sheet 12 that can be used in process 100 and by paper conditioning system 10 to produce an embossed sheet 14. The plain sheet 12 described in Table 2 is 100% viscose nonwoven.

TABLE 2

| Characteristic | Value | |
|---|---|---|
| Thickness | 0.19 | mm |
| Weight | 23 | g |

| | |
|---|---|
| Tensile strength - Dry (MD) | 40N/5 cm |
| Tensile strength - Dry (CD) | 8N/5 cm |
| Elongation at peak - Dry (MD) | 10% |
| Elongation at peak - Dry (CD) | 20% |
| Tensile Strength - Wet (CD) | 5.5N/5 cm |
| Elongation at peak - Wet (CD) | 25% |
| Absorption capacity | 800% |

A third example is described in Table 3. Table 3 describes various properties and characteristics of another example of a plain paper sheet 12 that can be used in process 100 and by paper conditioning system 10 to produce an embossed paper sheet 14. The plain paper sheet 12 described in Table 3 is 100% Viscose.

TABLE 3

| Characteristic | Value | |
|---|---|---|
| Thickness | 0.23 | mm |
| Weight | 28 | g |

| | |
|---|---|
| Tensile strength - Dry (MD) | 42N/5 cm |
| Tensile strength - Dry (CD) | 12N/5 cm |
| Elongation at peak - Dry (MD) | 10% |
| Elongation at peak - Dry (CD) | 27% |
| Tensile Strength - Wet (MD) | 22N/5 cm |
| Tensile Strength - Wet (CD) | 7N/5 cm |
| Elongation at peak - Wet (MD) | 11% |
| Elongation at peak - Wet (CD) | 27% |
| Absorption capacity | 750% |

A fourth example is described in Table 4. Table 4 describes various properties and characteristics of another example of a plain paper sheet 12 that can be used in process 100 and by paper conditioning system 10 to produce an embossed paper sheet 14.

TABLE 4

| Characteristic | Value | | Test Method |
|---|---|---|---|
| Weight | 36 +/− 2 | g | ISO 536 |
| Tensile strength - Wet (MD) | >5.5N/15 mm | | Method Glatfelter |
| Porosity | >100 | l/m²s | EN ISO 9237 |
| Capillary rise (MD) | >110 mm/10 min | | ISO 8787 |
| pH value | 6.2 +/− 0.5 | | DIN 53124 |
| Max contamination (Tappi | 2.5 mm²/20 m² | | |
| dirt estimation chart) | | | |
| Max spot size (Tappi dirt | 0.7 | mm² | |

estimation chart)

A fifth example is described in Table 5. Table 5 describes various properties and characteristics of another example of a plain paper sheet 12 that can be used in process 100 and by paper conditioning system 10 to produce an embossed paper sheet 14.

TABLE 5

| Characteristic | Value | | Test Method |
|---|---|---|---|
| Weight | 27 +/− 2 | g | ISO 536 |
| Tensile strength - Wet (MD) | >5.5N/15 mm | | Method Glatfelter |
| Porosity | >220 | l/m²s | EN ISO 9237 |
| Capillary rise (MD) | >110 mm/10 min | | ISO 8787 |
| pH value | 6.2 +/− 0.5 | | DIN 53124 |
| Max contamination (Tappi | 2.5 mm²/20 m² | | |
| dirt estimation chart) | | | |
| Max spot size (Tappi dirt | 0.7 | mm² | |

estimation chart)

A sixth example is described in Table 6. Table 6 describes various properties and characteristics of another example of a plain paper sheet 12 that can be used in process 100 and by paper conditioning system 10 to produce an embossed paper sheet 14.

TABLE 6

| Characteristic | Value | | Test Method |
|---|---|---|---|
| Weight | 28 +/− 2 | g | ISO 536 |
| Tensile strength - Wet (MD) | >5.5N/15 mm | | Method Glatfelter |
| Porosity | >100 | l/m²s | EN ISO 9237 |
| Capillary rise (MD) | >70 mm/10 min | | ISO 8787 |
| pH value | 6.2 +/− 0.5 | | DIN 53124 |
| Max contamination (Tappi | 2.5 mm²/20 m² | | |
| dirt estimation chart) | | | |
| Max spot size (Tappi dirt | 0.7 | mm² | |

estimation chart)

A seventh example is described in Table 7. Table 7 describes various properties and characteristics of another example of a plain paper sheet 12 that can be used in process 100 and by paper conditioning system 10 to produce an embossed paper sheet 14.

TABLE 7

| Characteristic | Test Method | Units | Value | Tolerance |
|---|---|---|---|---|
| Weight | | g/m² | 36 | =/−2 g |
| Thickness | DIN EN ISO | mm | >0.06 | −0.01 |
| | 534 | | | |
| Moisture | | % | 4.0 | +/−2% |
| content | | | | |
| Tensile | DIN EN ISO | N/15 mm | >35 | Min. 25 |
| Strength MD | 1924-2 | | | |
| Elongation MD | DIN EN ISO | % | 1.4 | +/−0.5 |
| | 1924-2 | | | |
| Tensile | DIN EN ISO | N/15 mm | >25 | Min. 15 |
| Strength CD | 1924-2 | | | |
| Elongation CD | DIN EN ISO | % | 3.5 | +/−1.0 |
| | 1924-2 | | | |
| Air | DIN 53120-1 | ml/min | >1.7 | Min. 1.0 |
| permeability | | | | |
| Reflectance | DIN 53145 | % | 89 | Min. 80 |
| Factor (R₄₅₇) | | | | |

1. A method of forming an embossed wrapper for a hygiene product, the method comprising steps of:
advancing a plain, un-embossed paper sheet to a printing station,
applying a deposit to the plain, un-embossed paper sheet to provide a coated, un-embossed paper sheet,
drying the coated, un-embossed paper sheet,
moisturizing the coated, un-embossed paper sheet after the step of drying to provide a wetted, un-embossed paper sheet, and
embossing the wetted, un-embossed paper sheet to provide the embossed paper sheet.

2. The method of claim 1, further comprising drying the embossed paper sheet.

3. The method of claim 2, wherein each step of drying is performed in an oven.

4. The method of claim 2, wherein each step of drying is performed in a separate oven.

5. The method of claim 4, wherein the separate ovens vary from one another in at least one of heat intensity/magnitude and length.

6. The method of claim 1, wherein the step of applying the deposit includes applying a primer layer to the plain, un-embossed paper sheet.

7. The method of claim 6, wherein the step of applying the deposit includes applying a release layer to the primer layer.

8. The method of claim 7, wherein the step of applying the deposit includes applying a heat seal layer to the release layer.

9. The method of claim 8, wherein the step of applying the deposit includes applying an ink layer.

10. The method of claim 8, further comprising flipping the coated, un-embossed paper sheet and applying a second primer layer and a second heat seal layer on an opposite side of the coated, un-embossed paper sheet.

11. The method of claim 10, further comprising applying a first ink layer on a first side of the embossed paper sheet and applying a second ink layer on the opposite side of the coated, un-embossed paper sheet.

12. The method of claim 1, wherein the step of moisturizing includes advancing the coated, un-embossed paper sheet through a reservoir of liquid including water.

13. The method of claim 12, wherein the step of moisturizing further includes spraying liquid including water on the coated, un-embossed paper sheet after advancing the coated, un-embossed paper sheet through the reservoir of liquid.

14. The method of claim 12, wherein advancing the coated, un-embossed paper sheet through the reservoir includes selecting an amount of time that the coated, un-embossed paper sheet is submerged in the reservoir so that the wetted, un-embossed paper sheet has a predetermined moisture content following the step of advancing the coated, un-embossed paper sheet through the reservoir of liquid.

15. The method of claim 13, wherein spraying the liquid on the coated, un-embossed paper sheet includes discharging a predetermined amount of liquid from one or more spray nozzles toward the coated, un-embossed paper sheet so that the wetted, un-embossed paper sheet has a predetermined moisture content following the step spraying the liquid including water on the coated, un-embossed paper sheet.

16. The method of claim 1, wherein the step of embossing includes rolling the wetted, un-embossed paper sheet between a metallic roller having a plurality of protrusions projecting toward the wetted, un-embossed paper sheet and a rubber roller.

17. The method of claim 1, wherein the plain, un-embossed paper sheet is wound in a roll prior to the step of advancing the plain, un-embossed paper sheet to the printing station, and the step of advancing the plain, un-embossed paper sheet to the printing station includes applying a tensile force on the plain, un-embossed paper sheet above a tear strength of the embossed paper sheet.

18. The method of claim 17, further comprising a step of re-winding the embossed paper sheet into a second roll.

19. A conditioning system configured to form an embossed sheet, the conditioning system comprising:
a printing station configured to apply one or more deposits on an un-embossed sheet,
a drying station configured to cure the one or more deposits on the un-embossed sheet to provide a coated, un-embossed sheet,
a conditioning station configured to receive the coated, un-embossed sheet and provide a conditioned, un-embossed sheet,
an embossing station configured to emboss the conditioned, un-embossed sheet to provide the embossed sheet.

20. The conditioning system of claim 19, wherein the un-embossed sheet is made from viscose nonwoven, the conditioning station includes a first heating stating configured to pass the coated, un-embossed sheet between two heated rollers, and a second heating station in which the coated, un-embossed sheet is further heated after the first heating station by an infrared heater to provide the conditioned, un-embossed sheet.
